(19) United States
(12) Patent Application Publication
(10) Pub. No.: US 2006/0248566 A1
(43) Pub. Date: Nov. 2, 2006

(54) Amplifier for use with voice over internet protocol signal

(76) Inventor: Tibor Urbanek, Boynton Beach, FL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/011,393

(22) Filed: Dec. 14, 2004

(51) Int. Cl. H04N 7/173

(52) U.S. Cl. 725/127; 725/118

(57) ABSTRACT

An amplifier circuit for amplifying a downstream signal carrying voice over internet protocol data is disclosed. The amplifier circuit includes an input which receives the downstream signal, an amplifier, an output, and a bypass circuit. The amplifier receives the downstream signal from the input and amplifies the downstream signal. The amplifier then outputs an amplified signal carrying voice over internet protocol data. The output receives the amplified signal from the amplifier and is connected with an external device capable of receiving and converting voice over internet protocol data to sound. The bypass circuit connects the input directly to the output. Upon activation of the bypass circuit, the downstream signal is transmitted directly from the input to the output and bypasses the amplifier.

### BACKGROUND

This invention relates generally to amplifiers, and more specifically to an amplifier specifically designed to handle a voice over internet protocol (VOIP) signal.

In VOIP or other data and TV transmission applications which are used on a two-way cable television (CATV) system, data is typically transmitted from a base station to an end user carried on a frequency bandwidth of 52-1000 MHz, called the downstream signal. Data which is transmitted from the user to the base station is transmitted on a frequency bandwidth of 5-42 MHz, called the upstream signal. Electronic devices which are connected at the end user or base station ends, such as telephony devices and cable modems, separate and combine the upstream and downstream signals internally as necessary for receiving or sending data carried on these signals.

Initially, two-way CATV communications systems did not transmit VOIP data using the downstream and upstream signals since the signals were only being transmitted for use by computers and televisions sets. Losing power for this form of data transmission was not important since computers and TV sets do not work without power either. However, cable and other companies have started to offer telephones through the cable system using signals which transmit VOIP data. Voice conversation is translated into VOIP data and transmitted the same way as any other computer data, such as through the internet. In order to fully compete with telephone companies, VOIP data transmission must be extremely reliable. One of the weak links in VOIP data transmission is supplying the power to external devices which receive VOIP data. Since the conventional telephone system is powered directly from a main office, the telephones still operate when the electrical power fails. However, in a VoIP telephone system, VOIP devices rely on electrical power received from traditional power companies. When the electrical power fails, a VOIP telephone cannot operate, unlike a traditional telephone. Since everybody is used to telephone working even if power is out, some VOIP devices are equipped with a battery back-up, so that if the electrical power fails in an area, the VOIP device can still operate.

However, many CATV home networks employ the use of an amplifier 20 which receives a downstream signal 34 at an input 24 from the base stations and amplifies the signal 34 using an amplifier 22, as illustrated in FIG. 1. The amplifier 22 outputs an amplified signal 38 with increased signal strength so that the signal may be sent a further distance. High/low filters 28, 30 are employed to allow only the downstream signal 34 to be sent to the amplifier 22 and only the upstream signal 36 to be sent to the base station. A power supply 32 supplies power to the amp 22. In most cases, the amplifier 20 amplifies only downstream signal 34, since the level of the upstream signal 36 is usually high enough.

If the power supply 32 ceases to provide power to the amplifier 22, as in a power outage, not only does the amplifier 22 not amplify the downstream signal 34 anymore, but the amplifier 22 actually attenuates the level of the downstream signal, sometimes by as much as by 30 dB or more. As a result, VOIP data carried by the downstream signal 34 cannot be used by external devices since the downstream signal 34 is too weak. Therefore, a need exists therefore an amplifier which does not attenuate signals when power is not supplied to the amplifier.

### SUMMARY

The present invention is defined by the following claims, and nothing in this section should be taken as a limitation on those claims. By way of introduction, the preferred embodiments described below relate to an amplifier circuit for amplifying a downstream signal carrying voice over internet protocol data. The amplifier circuit includes an input which receives the downstream signal, an amplifier, an output, and a bypass circuit. The amplifier receives the downstream signal from the input and amplifies the downstream signal. The amplifier then outputs an amplified signal carrying voice over internet protocol data. The output receives the amplified signal from the amplifier and is connected with an external device capable of receiving and converting voice over internet protocol data to sound. The bypass circuit connects the input directly to the output. Upon activation of the bypass circuit, the downstream signal is transmitted directly from the input to the output and bypasses the amplifier.

The preferred embodiments further relate to an amplifier for amplifying a signal comprising an amplifier circuit for amplifying a downstream signal carrying voice over internet protocol data. The amplifier circuit includes an amplifier connected between an input and an output of the amplifier circuit and a bypass circuit. The bypass circuit connects the input directly to the output. Upon activation of the bypass circuit, the downstream signal is transmitted directly from the input to the output and bypasses the amplifier.

The preferred embodiments further relate to an amplifier circuit for amplifying a downstream signal carrying voice over internet protocol data. The circuit includes an amplifier having an input and an output, and a bypass circuit. The amplifier receives and amplifies the downstream signal. The bypass circuit has an input connected with the amplifier input and an output connected with the amplifier output. Upon activation of the bypass circuit, the downstream signal is transmitted directly from the input to the output of the bypass circuit and bypasses the amplifier.

### DESCRIPTION OF THE DRAWINGS

FIG. 1 depicts a schematic view of an amplifier circuit.

FIG. 2 depicts a schematic view of an amplifier circuit, in accordance with one preferred embodiment of the invention.

FIG. 3 depicts a schematic view of an amplifier circuit, in accordance with one preferred embodiment of the invention.

FIG. 4 depicts a schematic view of an amplifier circuit, in accordance with one preferred embodiment of the invention.

FIG. 5 depicts a schematic view of an amplifier circuit, in accordance with one preferred embodiment of the invention.

FIG. 6 depicts a schematic view of an amplifier circuit, in accordance with one preferred embodiment of the invention.

FIG. 7 depicts a perspective view of an amplifier, in accordance with one preferred embodiment of the invention.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION

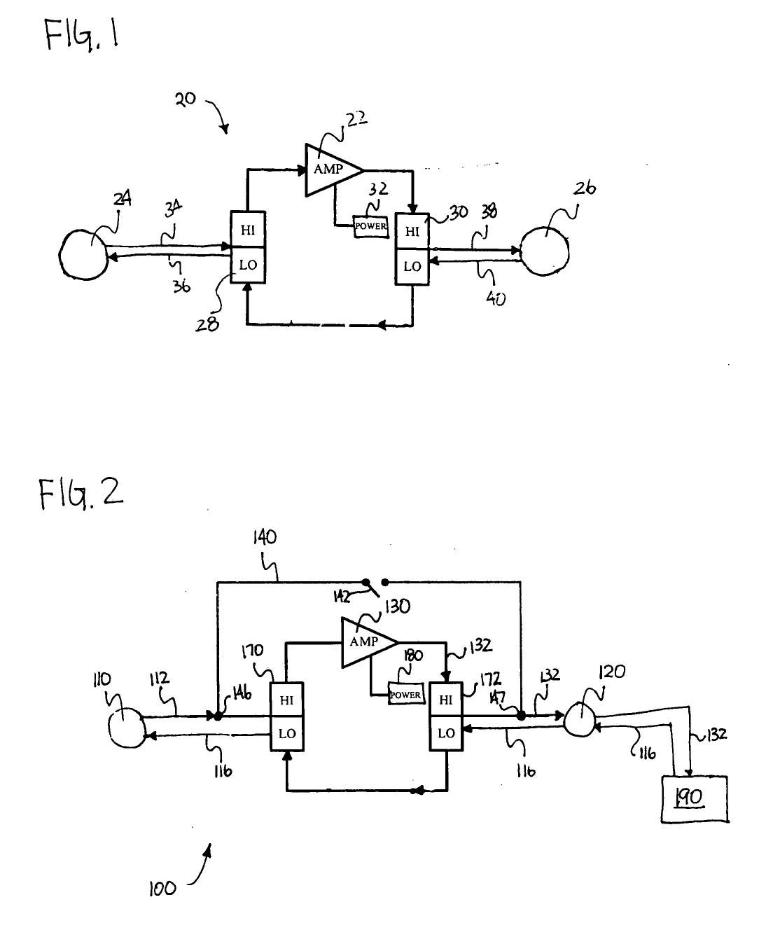

Referring to FIG. 2, there is shown a schematic view of an amplifier circuit 100, for amplifying a downstream signal 112 carrying voiceover internet protocol (VOIP) data, according to one preferred embodiment. The downstream signal 112 is any signal which can carry voiceover internet protocol data, such as a cable TV signal, a TV signal, any audio/video signal, a cable modem signal, a digital subscriber line signal, a telephone signal, and other such signals. Preferably, the downstream signal 112 is a digital signal used to provide cable television and cable modem services to a household. Preferably, the downstream signal 112 is carried on a frequency of between about 43 and 2000 megahertz and, more preferably, a frequency of between about 52 and 1000 megahertz. The amplifier circuit 100 is used to amplify the downstream signal 112 in order to increase the signal strength of the downstream signal 112 so that the downstream signal 112 may either be sent a longer distance or be sent to multiple devices instead of a single device.

The amplifier circuit 100 includes an input 110 connected in series with an amplifier 130 and an output 120. The input 110 receives the downstream signal 112 and sends the downstream signal 112 to the amplifier 130. The amplifier 130 receives the downstream signal 112 from the input 110 and amplifies the downstream signal 112. The amplifier 130 can be any electronic device which can be used to amplify an electronic signal, such as the downstream signal 112. The amplifier 130 is preferably connected to a power supply 180 which supplies power to the amplifier 130. Once the amplifier 130 receives a signal, such as the downstream signal 112, the amplifier 130 then uses power from the power supply 180 increases the signal strength of the signal. Upon receiving the downstream signal 112, the amplifier 130 amplifies the downstream signal 112 and then outputs an amplified signal 132. Preferably the amplified signal 132 is from 5 to 50 decibels greater than the downstream signal 112, and more preferably, the amplified signal 132 is from 10 to 30 decibels greater than the downstream signal 112.

The output 120 receives the amplified signal 132 from the amplifier 130 and, preferably, outputs the amplified signal 132 to an external device 190, as illustrated in FIG. 2. The external device 190 may be capable of receiving and converting voiceover internet protocol data into sound. Examples of external device 190 include a cable box, a television set, a VOIP enabled telephone, a computer, and a cable modem. Additionally, the output 120 also receives an upstream signal 116 from the external device 190. Preferably, the upstream signal 116 is a digital signal used to provide cable television and cable modem services to a household. Preferably, the upstream signal 116 is carried on a frequency of between about 1 and 2000 megahertz and, and more preferably a frequency between about 1 and 200 megahertz, and most preferably, a frequency of between about 5 and 42 megahertz.

The amplifier circuit 100 also includes a bypass circuit 140 having an input 146 and an output 147, as illustrated in FIGS. 2-6. The bypass circuit 140 may be activated manually or automatically upon loss of electrical power. Upon activation of the bypass circuit 140, the downstream signal 112 is transmitted directly from the input 146 to the output 147 of the bypass circuit 140 and therefore bypasses the amplifier 130. By providing a bypass circuit 140, the amplifier circuit 100 of the present invention allows the downstream signal 112 to pass from the input 110 to the output 120 without having to go through the amplifier 130. Therefore, when the power supply 180 fails to supply the amplifier 130 with power, the downstream signal 112 does not suffer from any attenuation which may result when the signal 112 passes through the amplifier 130, since the downstream signal 112 bypasses the amplifier 130 completely.

In one embodiment the amplifier circuit 100 includes a first hi-pass/low-pass filter 170 connected between the input 110 and the amplifier 130, as shown in FIG. 2. The first hi-pass/low-pass filter 170 preferably allows only downstream signals 112 to pass through the amplifier 130. Preferably, the first hi-pass/low-pass filter 170 only allows signals carried on a frequency of between 43 and 2000 megahertz and, more preferably, signals carried on a frequency of between 52 to 1000 megahertz to pass through to the amplifier 130. The first hi-pass/low-pass filter 170 also receives upstream signals 116 from the output 120 and only allows upstream signals 116 to pass through the first hi-pass/low-pass filter 170 to the input 110. Preferably, the first hi-pass/low-pass filter 170 only allows upstream signals 116 carried on a frequency of between 1 and 200 megahertz and more preferably 5 to 42 megahertz to pass through to the input 110.

In one embodiment the amplifier circuit 100 includes a second hi-pass/low-pass filter 172 connected between the output 120 and the amplifier 130, as shown in FIG. 2. The second hi-pass/low-pass filter 172 preferably allows only downstream signals 112 or amplified signals 132 to pass through to the external device 190. Preferably, the second hi-pass/low-pass filter 172 only allows signals carried on a frequency of between 43 and 2000 megahertz and, more preferably, signals carried on a frequency of between 52 to 1000 megahertz to pass through to the external device 190. The second hi-pass/low-pass filter 172 also receives upstream signals 116 from the output 120 and only allows upstream signals 116 to pass through the second hi-pass/low-pass filter 172 to the input 110. Preferably, the second hi-pass/low-pass filter 172 only allows upstream signals 116 carried on a frequency of between 1 and 200 megahertz and more preferably 5 to 42 megahertz to pass through to the input 110.

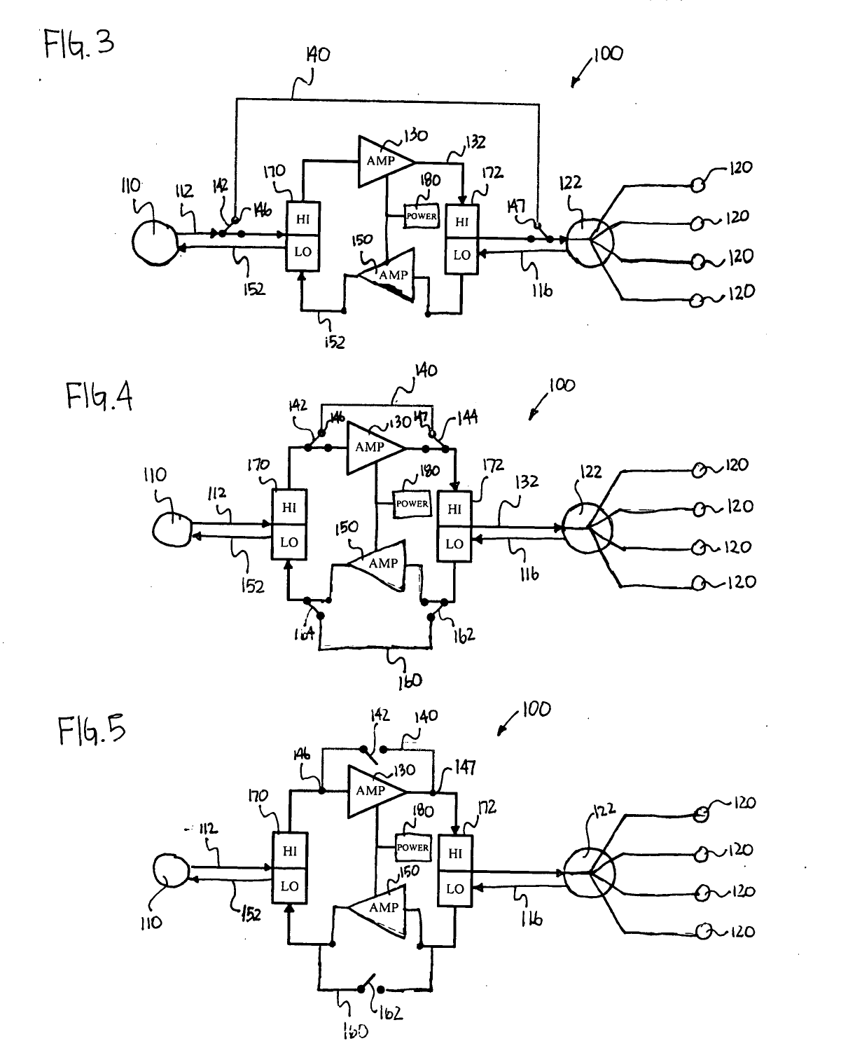

One embodiment the amplifier circuit 100 includes a splitter 122 located before the output 120 for outputting the amplified signal 132 to multiple external devices 190, as illustrated in FIGS. 3-6. The splitter 122 receives the downstream signal 112 or the amplified signal 132 and divides either the downstream signal 112 or the amplified signal 132 into multiple signals which are then routed to multiple outputs 120 as illustrated in FIGS. 3 through 6. In one embodiment, the splitter 122 includes a dedicated VOIP signal output 124, as illustrated in FIG. 6. In this embodiment, the output 147 of the bypass circuit 140 is directly connected to the dedicated VOIP signal output 124, thus being able to provide only the output 124 with an unamplified downstream signal 112 upon activation of the bypass circuit 140.

In one embodiment the amplifier circuit 100 includes a second amplifier 150 connected in series between the input 110 and the output 120, as illustrated in FIGS. 3 through 6. The second amplifier 150 receives the upstream signal 116 from the output 120 and amplifies the upstream signal 116. The second amplifier 150 can be any electronic device which can be used to amplify an electronic signal, such as the upstream signal 116. The second amplifier 150 is preferably also connected to the power supply 180 which supplies power to the amplifier 150. Once the amplifier 150 receives a signal, such as the upstream signal 116, the amplifier 150 then uses power from the power supply 180 to increase the signal strength of the signal. Upon receiving the upstream signal 116, the amplifier 150 amplifies the upstream signal 116 and then outputs an amplified signal 152. Preferably the amplified signal 152 is from 5 to 50 decibels greater than the upstream signal 116 and, even more preferably, the amplified signal 152 is from 10 to 30 decibels greater than the upstream signal 116.

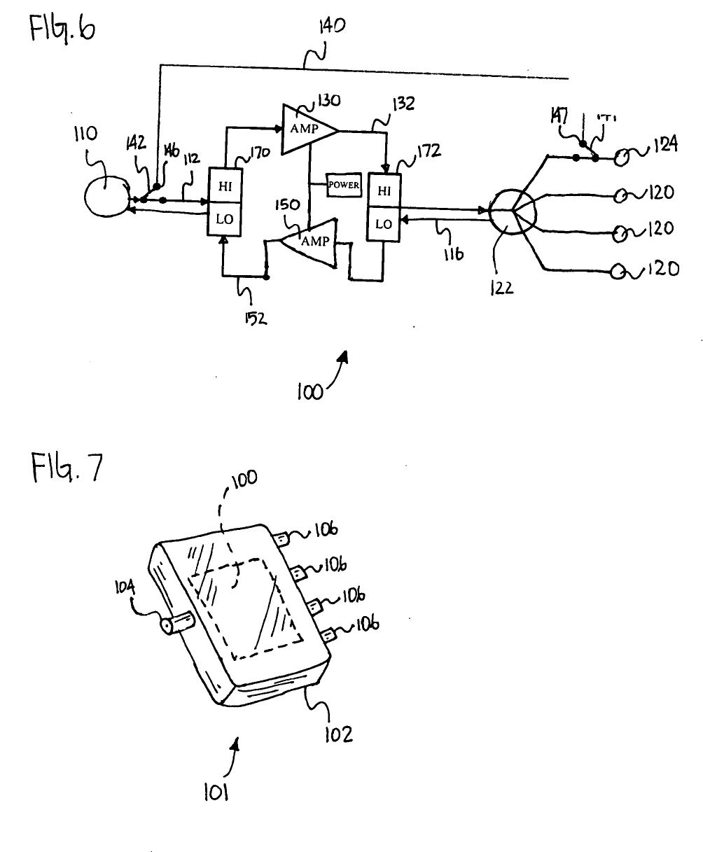

In one embodiment the amplifier circuit 100 includes a second bypass circuit 160 connecting the output 120 directly to the input 110, as illustrated in FIGS. 4 and 5. Upon activation of the second bypass circuit 160, the upstream signal 116 is transmitted directly from the output 120 to the input 110 and bypasses the second amplifier 150. By providing a second bypass circuit 160, the amplifier circuit 100 of the present invention allows the upstream signal 116 to pass from the output 120 to the input 110 without having to go through the amplifier 150. Therefore, when the power supply 180 fails to supply the amplifier 150 with power, the upstream signal 116 does not suffer from any attenuation which may result when the upstream signal 116 passes through the amplifier 150, since the upstream signal 116 bypasses the amplifier 150 completely.

Referring to FIG. 7, there is shown a perspective view of an amplifier device 101 in accordance with one preferred embodiment of the invention. The amplifier device 101 includes a housing 102 and the amplifier circuit 100. Housing 102 houses the amplifier circuit 100 as illustrated in FIG. 7. Additionally, the amplifier device 101 also includes an input connector 104 connected with the input 110 and an output connector 106 connected with each output 120 as illustrated in FIG. 7. Preferably the input connector 104 and the output connector 106, one of the following types of connectors, an F-type connector, an RCA, a balanced input connector, a BNC type connector and any other type of connector which may be used to connect audio/video signals and other types of signals. Preferably input and output connectors 104, 106 are coaxial F-type connectors. Moreover, the amplifier device 101 may include an external power adapter 200 connected to the housing 102 and the amplifier 130 via a power cord 202, in order to provide power to the amplifier 130.

Although the invention has been described and illustrated with reference to specific illustrative embodiments thereof, it is not intended that the invention be limited to those illustrative embodiments. Those skilled in the art will recognize that variations and modifications can be made without departing from the spirit of the invention.

1. An amplifier circuit for amplifying a downstream signal carrying voice over internet protocol data comprising:
an input which receives the downstream signal;
an amplifier which receives the downstream signal from the input and amplifies the downstream signal, wherein the amplifier outputs an amplified signal carrying voice over internet protocol data;
an output which receives the amplified signal from the amplifier, wherein the output is connected with an external device capable of receiving and converting voice over internet protocol data to sound; and
a bypass circuit connecting the input directly to the output, wherein upon activation of the bypass circuit, the downstream signal is transmitted directly from the input to the output and bypasses the amplifier.

2. The amplifier circuit of claim 1, wherein the downstream signal is between 43 and 2000 MHz.

3. The amplifier circuit of claim 1, wherein the amplified signal is from 5 to 50 decibels greater that the downstream signal.

4. The amplifier circuit of claim 1 further comprising a first high-pass/low-pass filter connected between the input and the amplifier, wherein the first high-pass/low-pass filter only allows downstream signals to pass through to the amplifier.

5. The amplifier circuit of claim 1 further comprising a second high-pass/low-pass filter connected between the output and the amplifier, wherein the second high-pass/low-pass filter only allows downstream signals to pass through to the external device capable of receiving and converting voice over internet protocol data to sound.

6. The amplifier circuit of claim 1 further comprising a splitter located before the output for outputting the amplified signal to multiple external devices.

7. An amplifier for amplifying a signal comprising an amplifier circuit for amplifying a downstream signal carrying voice over internet protocol data, wherein the amplifier circuit comprises:
an amplifier connected between an input and an output of the amplifier circuit, and
a bypass circuit connecting the input directly to the output, wherein upon activation of the bypass circuit, the downstream signal is transmitted directly from the input to the output and bypasses the amplifier.

8. The amplifier of claim 7, wherein the downstream signal is between 43 and 2000 MHz.

9. The amplifier of claim 7, wherein the amplifier circuit further comprises a first high-pass/low-pass filter connected between the input and the amplifier, wherein the first high-pass/low-pass filter only allows downstream signals to pass through to the amplifier.

10. The amplifier of claim 7, wherein the amplifier circuit further comprises a second high-pass/low-pass filter connected between the output and the amplifier, wherein the second high-pass/low-pass filter only allows downstream signals to pass through to the output.

11. The amplifier of claim 7, wherein the amplifier circuit further comprises a splitter located before the output for outputting the amplified signal to multiple external devices.

12. The amplifier of claim 7 further comprising an input connector connected with the input and an output connector connected with the output.

13. The amplifier of claim 7 further comprising a power supply connected with the amplifier.

14. An amplifier circuit for amplifying a downstream signal carrying voice over internet protocol data comprising:
an amplifier having an input and an output, wherein the amplifier receives and amplifies the downstream signal; and
a bypass circuit having an input connected with the amplifier input and an output connected with the amplifier output, wherein upon activation of the bypass circuit, the downstream signal is transmitted directly from the input to the output of the bypass circuit and bypasses the amplifier.

15. The amplifier circuit of claim 14, wherein the bypass circuit comprises a switch, wherein upon activation of the switch, the downstream signal is transmitted directly from the input to the output of the bypass circuit and bypasses the amplifier.

16. The amplifier circuit of claim 14, wherein the bypass circuit comprises one of a mechanical switch, a relay, a manual switch, and an electronic switch.

17. The amplifier circuit of claim 14 further comprising a splitter located after the amplifier, the splitter having multiple outputs for outputting the amplified signal to multiple external devices.

18. The amplifier circuit of claim 17, wherein the output of the bypass circuit is connected directly to an output of the splitter.

19. The amplifier circuit of claim 14 further comprising a first high-pass/low-pass filter connected before the amplifier, wherein the first high-pass/low-pass filter only allows downstream signals to pass through to the amplifier.

20. The amplifier circuit of claim 19, wherein the wherein the downstream signal is between 43 and 2000 MHz.
